(19) United States
(12) Patent Application Publication
(10) Pub. No.: US 2015/0213045 A1
(43) Pub. Date: Jul. 30, 2015

(54) Methods And Systems For Storing Replicated Data In The Cloud

(71) Applicant: Alcatel-Lucent Israel LTD., Petah Tikva (IL)

(72) Inventors: Amalia Avraham, Petach Tikva (IL); David Edery, Netanya (IL); Assaf Sinvani, Modi'in (IL)

(21) Appl. No.: 14/164,083

(22) Filed: Jan. 24, 2014

(51) Int. Cl. G06F 17/30

(52) U.S. Cl. CPC G06F 17/30132; G06F 17/30578; G06F 17/30581

(57) ABSTRACT

Critical data may be synchronously stored in both a cache, and a database of a remote data repository of a cloud-based network. Alternatively, critical data may be synchronously stored in the cache, and critical and/or non-critical data may be asynchronously stored in the database.

### BACKGROUND

In a distributed cloud-based network, data must be replicated and stored at multiple locations. Data may be classified as “critical” and “non-critical” data. In general, critical data may be data that is required very quickly after its creation by all participants of a cloud-base network, such as business logic constraints (e.g. unique cross-cloud names, resource lock states etc . . . ). Conversely, non-critical data is data that is not required as fast as critical data (e.g., resource description, name, creation times). Accordingly, it is desirable to provide methods and related systems for replication and storage of critical and non-critical data in a cloud-based network.

### SUMMARY

Exemplary embodiments of methods and systems for storing critical and non-critical data in a cloud based network are described herein.

In one embodiment, a method for storing replicated data comprises: receiving data at a remote data repository; and storing the received data at the remote data repository based on a replication mode, wherein the replication mode is selected from among a group of modes that includes a mode for synchronously storing critical data within the received data in a cache of the repository and storing at least the data stored in the cache in a database of the repository.

Variations of the embodiment just described include: (i) storing the received data at the remote data repository based on a replication mode, wherein the replication mode is selected from among the group of modes that includes a mode for synchronously storing the critical data in the cache of the repository and asynchronously storing non-critical data within the received data in the database of the remote data repository; (ii) storing the received data at the remote data repository based on a replication mode, wherein the replication mode is selected from among the group of modes that includes a mode for synchronously storing critical data within the received data in a cache of the repository and asynchronously storing the critical data and non-critical data within the received data in the database of the remote data repository; (iii) storing the received data at the remote data repository based on a replication mode, wherein the replication mode is selected from among the group of modes that includes a mode for synchronously storing the critical data in a cache of the repository and synchronously storing at least the critical data in the database of the remote data repository; and (iv) storing the received data at the remote data repository based on a replication mode, wherein the replication mode is selected from among the group of modes that includes a mode for synchronously storing the critical data in the cache of the remote data repository or asynchronously storing non-critical data within the received data in the database of the remote data repository.

The methods described above may be repeated at each remote data repository. For example, in another embodiment a method may comprise: receiving next data at a next remote data repository; and storing the next, received data at the next remote data repository based on a replication mode, wherein the replication mode is selected from among a group of modes that includes a mode for synchronously storing critical data within the next data in a cache of the repository and storing at least the data stored in the cache in a database of the repository.

In addition to the methods described above, exemplary embodiments of systems for storing replicated data are provided. For example, one such system may comprise: one or more hardware servers, each server configured as a remote data repository operable to receive data, and store the received data based on a replication mode, wherein the replication mode is selected from among a group of modes that includes a mode for synchronously storing critical data within the received data in a cache and storing at least the data stored in the cache in a database.

One example of a hardware server is an application server.

Variations of the system described above include one or more hardware servers, each server configured as a remote data repository operable to receive data, and store the received data based on a replication mode, wherein the replication mode is selected from among the group of modes that includes: (i) a mode for synchronously storing the critical data in the cache and asynchronously storing non-critical data within the received data in a database; (ii) a mode for synchronously storing critical data within the received data in a cache of the repository and asynchronously storing the critical data and non-critical data within the received data in the database of the remote data repository; (iii) a mode for synchronously storing the critical data in a cache and synchronously storing at least the critical data in a database; and (iv) a mode for synchronously storing the critical data in a cache or asynchronously storing non-critical data within the received data in a database.

The replication and storage of data may be repeated at each server or remote data repository. For example, a “next” one of the one or more hardware servers configured as a remote data repository may be operable to receive next data, and store the next, received data based on a replication mode, wherein the replication mode is selected from among a group of modes that includes a mode for synchronously storing critical data within the next, received data in a cache and storing at least the next data stored in the cache in a database.

In addition to providing methods and systems for storing data, methods and systems are provided for retrieving stored data from a cloud-based network. One such embodiment may comprise: one or more hardware servers, each server configured as a remote data repository operable to receive a request to retrieve critical or non-critical data, determine whether the critical or non-critical data is stored in an associated storage device, retrieve the critical or non-critical data from an associated storage device based on a determination that the critical or non-critical data is stored at the associated storage device, and send the critical or non-critical data to a user.

Additional features of the present invention will be apparent from the following detailed description and appended drawings.

### BRIEF DESCRIPTION OF THE DRAWINGS

FIG. 1 depicts a simplified block diagram of a network, such as a cloud-based network, exemplifying one or more embodiments for storing replicated data in the cloud-based network.

FIG. 2 depicts a simplified flow diagram of one or more exemplary methods for storing replicated data in a cloud-based network.

### DETAILED DESCRIPTION, INCLUDING EXAMPLES

Exemplary embodiments of methods and systems for storing replicated data in a cloud-based network are described herein in detail and shown by way of example in the drawings. Throughout the following description and drawings, like reference numbers/characters refer to like elements.

It should be understood that, although specific exemplary embodiments are discussed herein there is no intent to limit the scope of the present invention to such embodiments. To the contrary, it should be understood that the exemplary embodiments discussed herein are for illustrative purposes, and that modified and alternative embodiments may be implemented without departing from the scope of the present invention. Further, though specific structural and functional details may be disclosed herein, these too are merely representative for purposes of describing the exemplary embodiments.

It should be noted that some exemplary embodiments are described as processes or methods (collectively “method” or “methods”). Although a method may be described as a series of sequential steps, the steps may be performed in parallel, concurrently or simultaneously. In addition, the order of each step within a method may be re-arranged. A method may be terminated when completed, and may also include additional steps not described herein.

It should be understood that when the terms “generating”, “determining”, “receiving”, “detecting”, “storing”, “sending” as well as other action or functional terms and their various tenses are used herein, that such actions or functions may be implemented or completed by one or more processors (collectively referred to as “processor”) operable to execute instructions stored in one or more memories (collectively referred to as “memory”). Such a processor and memory may be a part of a larger device (e.g., network device (server), access device, local client devices such as laptops, desktops, tablets and smartphones).

As used herein, the term “and/or” includes any and all combinations of one or more of the associated listed items. It should be understood that when an element is referred to, or described or depicted as being “connected” to another element it may be directly connected to the other element, or intervening elements may be present, unless otherwise specified. Other words used to describe connective or spatial relationships between elements or components should be interpreted in a like fashion. As used herein, the singular forms “a,” “an” and “the” are intended to include the plural form, unless the context indicates otherwise.

As used herein the term “user” may refer to a single user, or a plurality of users, or a single user device, or a plurality of user devices depending on the context.

As used herein, the term “embodiment” refers to an embodiment of the present invention.

The phrase “synchronous replication” means a process of replicating data during which time the originator of the data may wait for the replication process to be completed. Replication is completed at all involved locations (e.g., data repositories). Accordingly, any other participant (or associated device) within the cloud-based network, having the need to know about the synchronous replication of the data, will be immediately informed of its replication.

The phrase “asynchronous replication” means a process of replicating data during which time the originator of the data is not required, or does not have a need to, wait for the replication process to be completed. Accordingly, participants within a cloud-based network may not be assured that an entire set of data has been replicated.

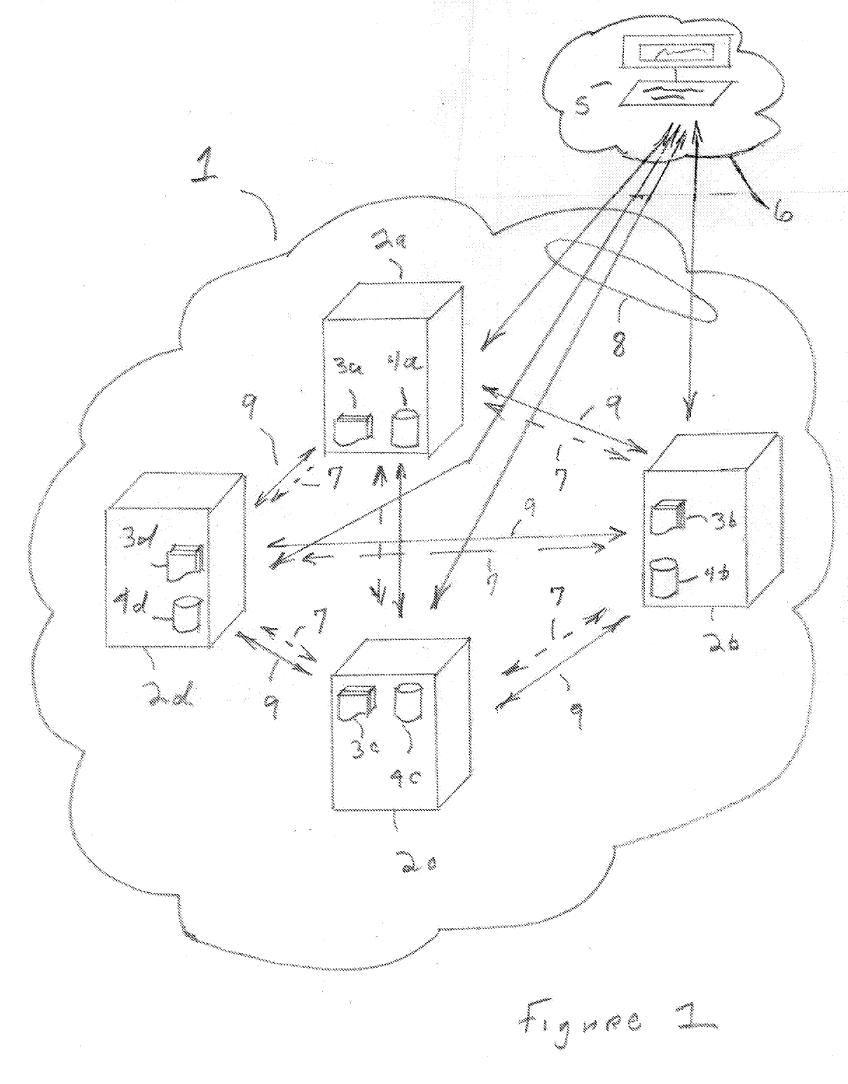

Referring now to FIG. 1 there is depicted a simplified block diagram of a network 1. In this embodiment the network 1 may comprise a cloud-based network, for example. The network 1 may comprise one or more different types of devices. For example, the cloud-based network 1 may comprise one or more (i.e., a “plurality”) of hardware servers 2a,2b,2c, . . . 2n, where “n” is the last server of the plurality of servers within the network 1. One example of a hardware server is an application server. Each server 2a,2b,2c, . . . 2n may further comprise one or more in-memory caches 3a,3b,3c, . . . 3n and one or more databases 4a,4b,4c, . . . 4n. The network 1 may be a part of, or may be connected to, a public telecommunications network 6. FIG. 1 also includes a user device 5 that may be connected to the network 1 directly, or through the public network 6 via wired or wireless communication links 8. Throughout the discussion herein, one or more of the devices depicted in FIG. 1 may be described as a “system”, such as a system that comprises one or more of the hardware servers 2a,2b,2c, . . . 2n and the user 5, for example. The operation of each of the devices (or systems) depicted in FIG. 1 is discussed herein.

Though only a single user device 5 is depicted in FIG. 1, it should be understood that a plurality of user devices may be connected to the network 1. In addition, among the plurality of user devices, it should be further understood that one or more of the devices may be associated with a single user, or, alternatively, a collection of devices may be associated with a single entity, such as a commercial or government entity.

Each of the devices 2a,2b,2c, . . . 2n, 3a,3b,3c, . . . 3n, 4a,4b,4c, . . . 4n and 5 shown in FIG. 1 may comprise a processor operable to execute instructions stored in associated instruction memory to complete functions, features and methods in accordance with embodiments of the present invention. For the sake of simplifying the description of the embodiments discussed herein, the included processor(s) and memory(s) are not shown in FIG. 1.

In accordance with exemplary embodiments, the devices shown in FIG. 1 may be operable to complete innovative functions, features and processes that overcome the limitations of traditional replication and storage devices or methods. In particular, the devices shown in FIG. 1 may be involved in the replication and storage of data that originates with the user 5. By data is meant information that may be replicated and stored, such as text, audio, video, measurements, input or output device control parameters and their related drivers, network interface control signals for modems, routers, switches, communication protocols, and file system parameters (e.g., file extensions, folders, documents, pictures, videos, audio files), to name just a few examples of the types of data that may be replicated and stored by the devices depicted in FIG. 1.

Turning now to the operation of one or more of the devices in FIG. 1, in one embodiment a system for storing replicated data may comprise one or more of the hardware servers 2a,2b,2c, . . . 2n where each server 2a,2b,2c, . . . 2n may be configured as a remote data repository. Each of the servers 2a,2b,2c, . . . 2n may be operable to receive data, and store the received data based on a replication mode. The replication mode may be selected from among a group of modes that includes a mode for synchronously storing critical data within the received data in a cache 3a,3b,3c, . . . 3n and storing at least the data stored in the cache in a database 4a,4b,4c, . . . 4n. In one embodiment, the data that is received by the one or more servers 2a,2b,2c, . . . 2n may originate with the user 5.

In embodiments of the invention, there are many variations of the above stated replication mode that may be used to store critical and non-critical data. For example, one of the modes may synchronously store received critical data in a cache 3a,3b,3c, . . . 3n via wired or wireless links 9 and asynchronously store non-critical data within the received data in a database 4a,4b,4c, . . . 4n via wired or wireless communication links 7. One of the advantages provided by this mode is that the critical data may be stored quickly in the cache 3a,3b,3c, . . . 3n. Thus, a user 5 wishing to have immediate access to the critical data may be able to do so by accessing the data stored in a cache.

In addition to the mode just discussed, the replication mode may be selected from among a group of modes that includes a mode for synchronously storing critical data within the received data in a cache and, similarly, synchronously storing at least the critical data in the database. In yet a third type of replication mode, critical data may be stored synchronously in a cache while asynchronously storing the critical data and non-critical data in a database. This storage method allows for the quick operation of all servers 2a,2b,2c, . . . 2n that use the database 4a,4b,4c, . . . 4n and the cache 3a,3b,3c, . . . 3n because all critical data is persistent on all servers. For example, in the event a failure occurs in one of the servers 2a,2b,2c, . . . 2n all of the critical may be retrieved from each of data is also stored in all other servers, and the other servers 2a,2b,2c, . . . 2n without the fear of inconsistency of data among the other servers because the critical data has also been stored in all other servers 2a,2b,2c, . . . 2n.

In the embodiments described herein, the amount of critical data that may be stored synchronously may be a minimal amount of data to ensure that such data is stored quickly in order for the data to be available to a server 2a,2b,2c, . . . 2n quickly. Otherwise, synchronous storage may take too long, and, therefore, such data may not be available to a server 2a,2b,2c, . . . 2n when required.

The two embodiments discussed above store data in a cache and database. In yet another embodiment of the invention, each of the servers 2a,2b,2c, . . . 2n may be operable to store received data in either a cache or database. For example, in a further embodiment the replication mode may be selected from among the group of modes that includes a mode for synchronously storing received critical data in a cache, or asynchronously storing non-critical data in a database.

Though the discussion above may appear to focus on the storage of data at a single hardware server or remote data repository, it should be understood that each of the servers/repositories 2a,2b,2c, . . . 2n may be operable to store critical data and non-critical data. For ease of explanation each of the additional servers/repositories may be referred to as a “next” server or “next” remote data repository. Accordingly, in an additional embodiment a next one of the one or more hardware servers 2a,2b,2c, . . . 2n may be configured as a next, remote data repository. Further, such a next server/repository may be operable to receive next data. Upon receiving such data the server may be operable to store the received, next data based on a replication mode, wherein the replication mode is selected from among the group of modes that includes a mode for synchronously storing critical data within the next data in a cache 3a,3b,3c, . . . 3n and storing at least the data stored in the cache in a database 4a,4b,4c, . . . 4n.

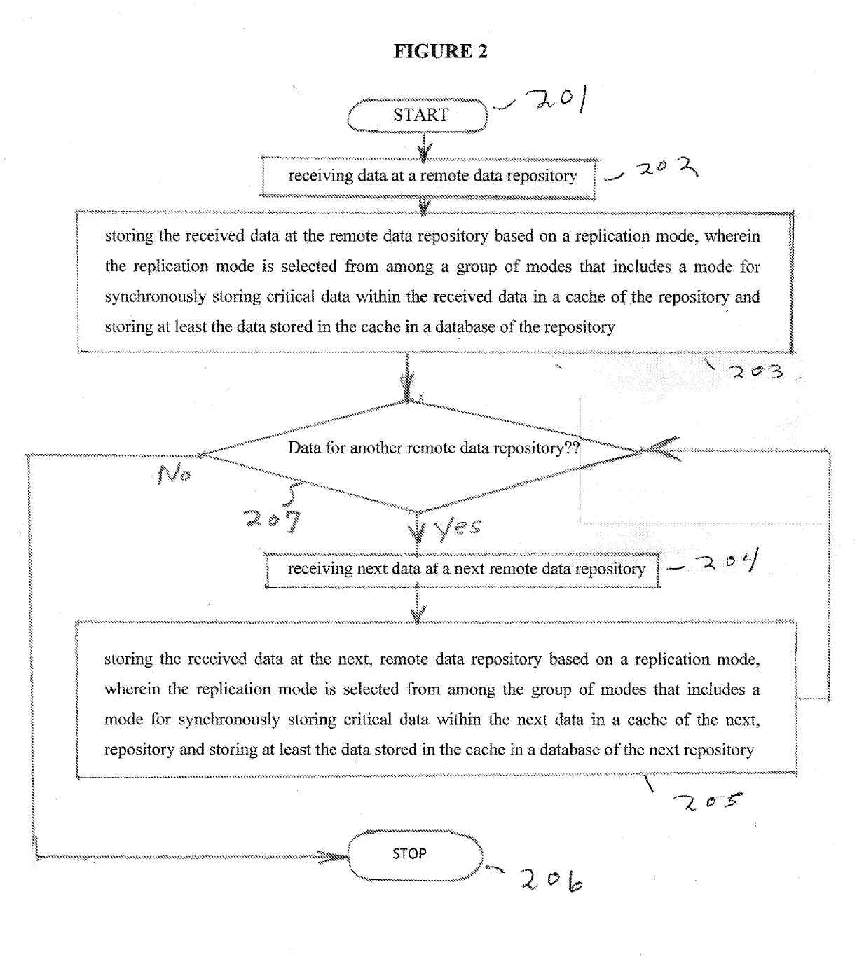

In addition to the systems described above, additional embodiments are directed at similar methods. For example, referring now to FIG. 2 there is depicted a simplified flow diagram of exemplary methods. As depicted in FIG. 2, one such method for storing replicated data may comprise receiving data at a remote data repository, in step 202, and storing the received data at the remote data repository based on a replication mode, wherein the replication mode is selected from among a group of modes that includes a mode for synchronously storing critical data within the received data in a cache of the repository and storing at least the data stored in the cache in a database of the repository, in step 203. Variations on this method may comprise storing the received data at the remote data repository based on a replication mode, wherein the replication mode is selected from among the group of modes that includes: (i) a mode for synchronously storing the critical data in the cache of the repository and asynchronously storing non-critical data within the received data in the database of the remote data repository; (ii) a mode for synchronously storing critical data in a cache of the repository and asynchronously storing the critical data and non-critical data within the received data in the database of the remote data repository; (iii) a mode for synchronously storing the critical data in a cache of the repository and synchronously storing at least the critical data in the database of the remote data repository; and (iv) a mode for synchronously storing the critical data in the cache of the remote data repository or asynchronously storing non-critical data within the received data in the database of the remote data repository.

Though the discussion above may appear to focus on methods for storing data at a single hardware server, it should be understood that additional embodiments are directed methods for storing data at additional, next servers or remote data repositories. For example, an alternative method may comprise receiving next data at a next remote data repository, in step 204, and storing the received data at the next, remote data repository based on a replication mode, wherein the replication mode is selected from among the group of modes that includes a mode for synchronously storing critical data within the next data in a cache of the next, repository and storing at least the data stored in the cache in a database of the next repository, in step 205.

In addition to providing embodiments for storing critical and non-critical data, the present invention also provides for embodiments that retrieves data from servers/remote data repositories. In one embodiment such a system may comprise one or more hardware servers 2a,2b,2c, . . . 2n configured as remote data repositories, where the one or more servers 2a,2b,2c, . . . 2n may be operable to receive a request to retrieve critical or non-critical data, determine whether such critical or non-critical data is stored in an associated storage device 3a,3b,3c, . . . 3n or 4a,4b,4c, . . . 4n of one or more of the servers 2a,2b,2c, . . . 2n, retrieve the critical or non-critical data from one or more of the associated storage devices 3a,3b,3c, . . . 3n or 4a,4b,4c, . . . 4n based on a determination that the critical or non-critical data is stored at the associated storage devices 3a,3b,3c, . . . 3n or 4a,4b,4c, . . . 4n, and then send the critical or non-critical data to a user 5.

In more detail, suppose the user device 5 wishes to retrieve critical or non-critical data from the one or more servers 2a,2b,2c, . . . 2n. In one embodiment, a request to retrieve such data may be generated by the user device 5, for example, and sent to the one or more servers 2a,2b,2c, . . . 2n.

Upon receiving a request at one or more of the servers 2a,2b,2c, . . . 2n the involved server(s) (i.e., the one(s) that receive the request) may be operable to receive the request and determine whether the requested critical or non-critical data is stored in an associated storage device, such as cache 3a,3b,3c, . . . 3n or a database 4a,4b,4c, . . . 4n. After determining that the requested data is, indeed, stored at a storage device 3a,3b,3c, . . . 3n or 4a,4b,4c, . . . 4n the involved server or servers 2a,2b,2c, . . . 2n may be operable to retrieve the requested data from the so-located associated, storage device(s) 3a,3b,3c, . . . 3n or 4a,4b,4c, . . . 4n and send the data to the user 5.

In more detail, upon receiving a request to retrieve critical data an involved server 2a,2b,2c, . . . 2n may be operable to further determine whether the critical data is stored in a cache, such as cache 3a,3b,3c, . . . 3n or a database 4a,4b,4c, . . . 4n, or, in both a cache 3a,3b,3c, . . . 3n and database 4a,4b,4c, . . . 4n. After determining the associated storage device or devices where the critical data is stored, the involved server 2a,2b,2c, . . . 2n may be operable to retrieve the critical data from the so-located, associated storage device or devices and send it to the user 5.

Alternatively, upon receiving a request to retrieve non-critical data an involved server 2a,2b,2c, . . . 2n may be operable to further determine the storage device or devices (e.g., database 4a,4b,4c, . . . 4n) where the non-critical data is stored. After determining the storage device or devices where the non-critical data is stored, the involved server 2a,2b,2c, . . . 2n may be operable to retrieve the non-critical data from the so-located storage device or devices (e.g., database) and send it to the user 5. Sometimes a request for non-critical data may be sent by a user 5 before the non-critical data has been stored in a database, for example. In such a scenario, the involved server 2a,2b,2c, . . . 2n may not be operable to retrieve the non-critical data from a particular database. Accordingly, an involved server 2a,2b,2c, . . . 2n may be further operable to detect that non-critical data is not stored at a located database 4a,4b,4c, . . . 4n. Thereafter, the involved server 2a,2b,2c, . . . 2n may be operable to detect a received signal indicating that the non-critical data is now stored at the located database 4a,4b,4c, . . . 4n. Upon detecting such a signal the involved server 2a,2b,2c, . . . 2n may be operable to retrieve the non-critical data that is now stored in the located database 4a,4b,4c, . . . 4n and send it to the user 5.

While exemplary embodiments have been shown and described herein, it should be understood that variations of the disclosed embodiments may be made without departing from the spirit and scope of the invention which is encompassed by the claims that follow.

What is claimed is:

1. A method for storing replicated data comprising:
receiving data at a remote data repository; and
storing the received data at the remote data repository based on a replication mode, wherein the replication mode is selected from among a group of modes that includes a mode for synchronously storing critical data within the received data in a cache of the repository and storing at least the data stored in the cache in a database of the repository.

2. The method as in claim 1 further comprising storing the received data at the remote data repository based on a replication mode, wherein the replication mode is selected from among the group of modes that includes a mode for synchronously storing critical data within the received data in a cache of the repository and asynchronously storing non-critical data within the received data in the database of the remote data repository.

3. The method as in claim 1 further comprising storing the received data at the remote data repository based on a replication mode, wherein the replication mode is selected from among the group of modes that includes a mode for synchronously storing critical data within the received data in a cache of the repository and asynchronously storing the critical data and non-critical data within the received data in the database of the remote data repository.

4. The method as in claim 1 further comprising storing the received data at the remote data repository based on a replication mode, wherein the replication mode is selected from among the group of modes that includes a mode for synchronously storing the critical data in a cache of the repository and synchronously storing at least the critical data in the database of the remote data repository.

5. The method as in claim 1 further comprising storing the received data at the remote data repository based on a replication mode, wherein the replication mode is selected from among the group of modes that includes a mode for synchronously storing the critical data in the cache of the remote data repository or asynchronously storing non-critical data within the received data in the database of the remote data repository.

6. The method as in claim 1 further comprising:
receiving next data at a next remote data repository; and
storing the next, received data at the next remote data repository based on a replication mode, wherein the replication mode is selected from among a group of modes that includes a mode for synchronously storing critical data within the next data in a cache of the repository and storing at least the data stored in the cache in a database of the repository.

7. A system for storing replicated data comprising:
one or more hardware servers, each server configured as a remote data repository operable to,
receive data; and
store the received data based on a replication mode, wherein the replication mode is selected from among a group of modes that includes a mode for synchronously storing critical data within the received data in a cache and storing at least the data stored in the cache in a database.

8. The system as in claim 7 wherein each of the one or more hardware servers comprises an application server.

9. The system as in claim 7, wherein each of the servers is further operable to store the received data based on a replication mode, wherein the replication mode is selected from among the group of modes that includes a mode for synchronously storing the critical data in the cache and asynchronously storing non-critical data within the received data in the database.

10. The system as in claim 7, wherein each of the servers is further operable to store the received data based on a replication mode, wherein the replication mode is selected from among the group of modes that includes a mode for synchronously storing critical data within the received data in a cache of the repository and asynchronously storing the critical data and non-critical data within the received data in the database of the remote data repository.

11. The system as in claim 7, wherein each of the servers is further operable to store the received data based on a replication mode, wherein the replication mode is selected from among the group of modes that includes a mode for synchronously storing the critical data in a cache and synchronously storing at least the critical data in the database.

12. The system as in claim 7, wherein each of the servers is further operable to store the received data based on a replication mode, wherein the replication mode is selected from among the group of modes that includes a mode for synchronously storing the critical data in a cache or asynchronously storing non-critical data within the received data in a database.

13. The system as in claim 7 further comprising:
a next one of the one or more hardware servers, the next server configured as a remote data repository operable to,
receive next data; and
store the next, received data based on a replication mode, wherein the replication mode is selected from among a group of modes that includes a mode for synchronously storing critical data within the next, received data in a cache and storing at least the next data stored in the cache in a database.

14. A system for retrieving stored data from a cloud-based network comprising:
one or more hardware servers, each server configured as a remote data repository operable to,
receive a request to retrieve critical or non-critical data;
determine whether the critical or non-critical data is stored in an associated storage device;
retrieve the critical or non-critical data from an associated storage device based on a determination that the critical or non-critical data is stored at the associated storage device; and
send the critical or non-critical data to a user.
